(19) United States
(12) Patent Application Publication
(10) Pub. No.: US 2024/0410491 A1
(43) Pub. Date: Dec. 12, 2024

(54) VALVE DEVICE

(71) Applicant: MIKUNI CORPORATION, Tokyo (JP)

(72) Inventors: Satoshi SEKIGUCHI, Kanagawa (JP); Shoichi Ishiguchi, Kanagawa (JP)

(73) Assignee: MIKUNI CORPORATION, Tokyo (JP)

(21) Appl. No.: 18/331,191

(22) Filed: Jun. 8, 2023

(30) Foreign Application Priority Data
Aug. 2, 2022 (JP) 2022-123050

(51) Int. Cl. F16K 31/06; F16K 1/36; F16K 1/42; F16K 1/54; F16K 27/02

(52) U.S. Cl. CPC F16K 31/0655; F16K 1/36; F16K 1/42; F16K 1/54; F16K 27/029

(57) ABSTRACT

A valve device includes: a housing 10, defining an upstream side passage 12a and a downstream side passage 13a through which a fluid passes and an operation chamber C and a valve seat surface 11d interposed between the upstream side passage and the downstream side passage; a valve body 20, being reciprocated in the operation chamber to be seated and disengaged with respect to the valve seat surface; and a driving unit U, having a shaft 40 linked with the valve body and driving the valve body. In the valve device, the upstream side passage 12a and the downstream side passage 13a are arranged on a same axis L, and the valve seat surface 11d is disposed to be inclined with respect to the axis L, with the axis L as the center.

### CROSS-REFERENCE TO RELATED APPLICATION

This application claims the priority benefit of Japan application serial no. 2022-123050, filed on Aug. 2, 2022. The entirety of the above-mentioned patent application is hereby incorporated by reference herein and made a part of this specification.

### BACKGROUND

### Technical Field

The invention relates to a valve device for opening and closing a passage of a fluid, and particularly relates to a valve device for opening and closing a passage through reciprocal movement so that a valve body is seated and disengaged with respect to a valve seat disposed in the middle of the passage.

### Description of Related Art

As a conventional valve device, an electromagnetic control valve or an electromagnetic valve including: an upstream side passage through which a fluid flows in; a downstream side passage through which the fluid flows out; a curved passage in a U shape or a crank shape connecting the upstream side passage and the downstream side passage; a valve seat surface formed perpendicular to a passage in the middle of the curved passage; a valve body moving reciprocally to be seated and disengaged with respect to the valve seat surface; and an electromagnetic control valve or an electromagnetic valve including a solenoid driving the valve body, etc., is known (see, for example, Patent Documents 1 to 3).

In the electromagnetic control valve or the electromagnetic valve, the fluid flowing in from the upstream side passage collides head-on with the valve body in the curved passage, and then flows through the periphery of the valve body to avoid the valve body and flows to the downstream side passage. That is, due to the collision of the flow body with the valve body, the loss of fluid pressure increases. In addition, since the upstream side passage and the downstream side passage are connected through the curved passage, the passage resistance is greater than that in a linear passage, which as well increases the loss of fluid pressure.

### PRIOR ART DOCUMENTS

### Patent Documents

[Patent Document 1] Japanese Laid-open No. S62-56679
[Patent Document 2] Japanese Laid-open No. H03-172694
[Patent Document 3] Japanese Laid-open No. 2002-250460

### SUMMARY

A valve device of the invention includes: a housing, defining an upstream side passage and a downstream side passage through which a fluid passes and an operation chamber and a valve seat surface interposed between the upstream side passage and the downstream side passage; a valve body, being reciprocated in the operation chamber to be seated and disengaged with respect to the valve seat surface; and a driving unit, having a shaft linked with the valve body and driving the valve body. The upstream side passage and the downstream side passage are arranged on a same axis, and the valve seat surface is disposed to be inclined with respect to the axis, with the axis as a center.

### BRIEF DESCRIPTION OF THE DRAWINGS

FIG. 1 is a perspective view illustrating the appearance of a valve device according to the first embodiment of the invention.

FIG. 2 is a perspective cross-sectional view taken by cutting off the valve device according to the first embodiment at a surface including an axis passing through centers of an upstream side passage and a downstream side passage and an axis of a shaft linked with a valve body.

FIG. 3 is a perspective view illustrating a housing included in the valve device according to the first embodiment.

FIG. 4 is a cross-sectional view taken by cutting off the valve device according to the first embodiment at the surface including the axis passing through the centers of the upstream side passage and the downstream side passage and the axis of the shaft linked with the valve body, and illustrating a valve opened state in which the valve body is disengaged from a valve seat surface.

FIG. 5 is a cross-sectional view taken by cutting off the valve device according to the first embodiment at the surface including the axis passing through the centers of the upstream side passage and the downstream side passage and the axis of the shaft linked with the valve body, and illustrating a valve closed state in which the valve body is seated at the valve seat surface.

FIG. 6 is a cross-sectional view taken at a surface parallel to the valve seat surface in the valve device according to the first embodiment when viewed in a direction perpendicular to the valve seat surface.

FIG. 7 is a perspective view illustrating the appearance of a valve device according to the second embodiment of the invention.

FIG. 8 is a perspective cross-sectional view taken by cutting off the valve device according to the second embodiment at a surface including an axis passing through centers of an upstream side passage and a downstream side passage and an axis of a shaft linked with a valve body.

FIG. 9 is a perspective view illustrating a housing included in the valve device according to the second embodiment.

FIG. 10 is a cross-sectional view taken by cutting off the valve device according to the second embodiment at the surface including the axis passing through the centers of the upstream side passage and the downstream side passage and the axis of the shaft linked with the valve body, and illustrating a valve opened state in which the valve body is disengaged from a valve seat surface.

FIG. 11 is a perspective cross-sectional view taken by cutting off the valve device according to the second embodiment at the surface including the axis passing through the centers of the upstream side passage and the downstream side passage and the axis of the shaft linked with the valve body, and illustrating a valve closed state in which the valve body is seated at the valve seat surface.

FIG. 12 is a cross-sectional view taken at a surface parallel to the valve seat surface in the valve device according to the second embodiment when viewed in a direction perpendicular to the valve seat surface.

### DESCRIPTION OF THE EMBODIMENTS

The invention provides a valve device which reduces a loss of fluid pressure due to a collision of the fluid with a valve body and reduces passage resistance.

A valve device of the invention includes: a housing, defining an upstream side passage and a downstream side passage through which a fluid passes and an operation chamber and a valve seat surface interposed between the upstream side passage and the downstream side passage; a valve body, being reciprocated in the operation chamber to be seated and disengaged with respect to the valve seat surface; and a driving unit, having a shaft linked with the valve body and driving the valve body. The upstream side passage and the downstream side passage are arranged on a same axis, and the valve seat surface is disposed to be inclined with respect to the axis, with the axis as a center.

In the valve device, a configuration in which, in the valve seat surface, a profile on an inner side is formed in an oval shape, and the valve body is formed in a circular shape may be adopted.

In the valve device, a configuration in which an annular seal member abuttable with the valve seat surface is mounted to the valve body may be adopted.

In the valve device, a configuration in which the valve seat surface is formed at a downstream end of the upstream side passage, and the valve body is closed in a direction resisting the fluid flowing in from the upstream side passage may be adopted.

In the valve device, a configuration in which the driving unit includes an electromagnetic actuator applying a driving force to the shaft may be adopted.

In the valve device, a configuration in which the electromagnetic actuator includes: a fixing element; a coil for excitation; and a mover linked with the shaft, moving to an operation position by conducting power to the coil, and returning to a rest position by not conducting power to the coil may be adopted.

In the valve device, a configuration in which the rest position corresponds to a valve-opened position at which the valve body is disengaged from the valve seat surface, and the operation position corresponds to a valve-closed position at which the valve body is seated at the valve seat surface may be adopted.

In the valve device, a configuration in which the shaft is disposed to be reciprocated in a direction perpendicular to the axis on which the upstream side passage and the downstream side passage are arranged may be adopted.

In the valve device, a configuration in which the shaft is disposed to be reciprocated in a direction perpendicular to the valve seat surface may be adopted.

According to the valve device with the configuration, the fluid can be prevented from colliding head-on with the valve body. Therefore, the loss of fluid pressure can be reduced, and the passage resistance can be reduced.

In the following, the embodiments of the invention will be described with reference to the accompanying drawings.

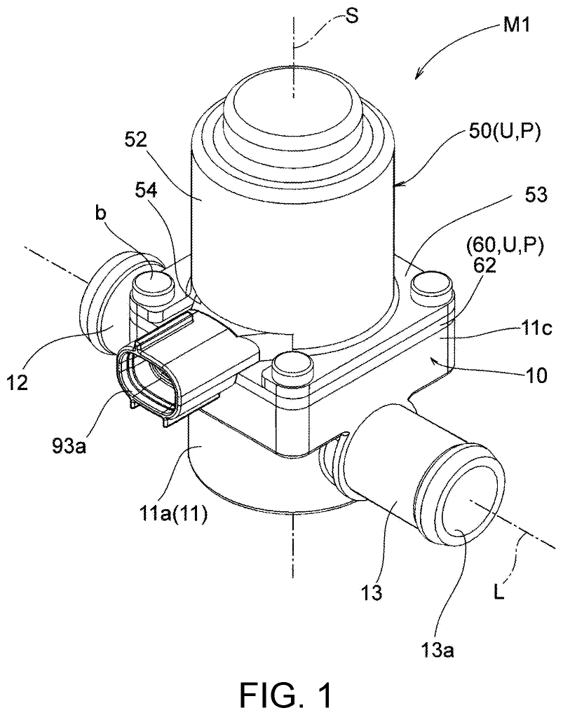

A valve device according to the invention is suitable for adjusting the flow of cooling water, as a fluid, in a cooling water circulation system of a vehicle, etc., for example. A valve device M1 according to the first embodiment, as shown in FIGS. 1 to 5, includes a housing 10, a valve body 20, a seal member 30, and a driving unit U fixed to the housing 10.s
The driving unit U includes a shaft 40 and an electromagnetic actuator A.

The housing 10 is formed by a resin material, etc., and includes a body part 11, an upstream side pipe part 12 with a center on an axis L, and a downstream side pipe part 13 with a center on the axis L.

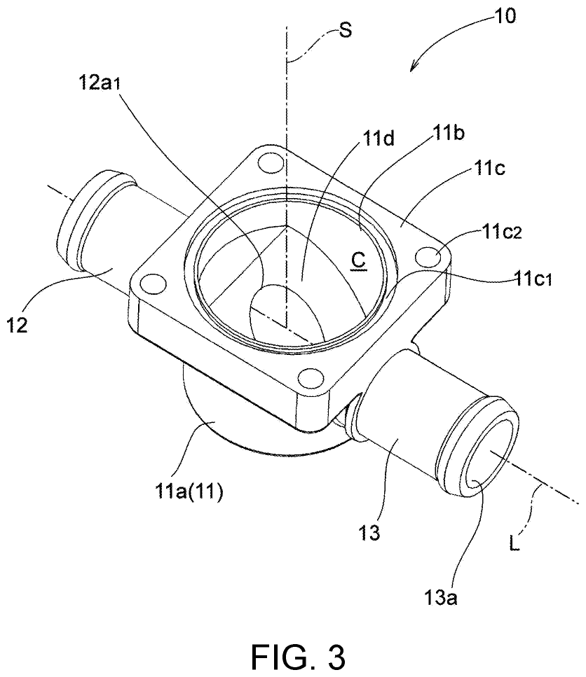

The body part 11, as shown in FIG. 3, includes a cylindrical wall 11a with an axis S perpendicular to the axis L as the center, an opening part 11b, and a flange part 11c. In addition, inside the body part 11, a valve seat surface 11d on which the valve body 20 is allowed to be seated and an operation chamber C in which the valve body 20 moves reciprocally are defined.
The cylindrical wall 11a is formed in a cylindrical shape with the axis S perpendicular to the axis L as the center, and the upstream pipe part 12 and the downstream pipe part 13 are elongated along the direction of the axis L in the radial direction.
The opening part 11b is a region in which the operation chamber C is open toward the outer side, and is blocked with the driving unit U being bonded.

The flange part 11c is a region to which the driving unit U is bonded and fixed and formed in a substantially rectangular profile on the periphery of the opening part 11b, and includes an annular groove 11c₁ with which the seal member 30 is fit and four female screw holes 11c₂ into which fastening screws b are screwed.

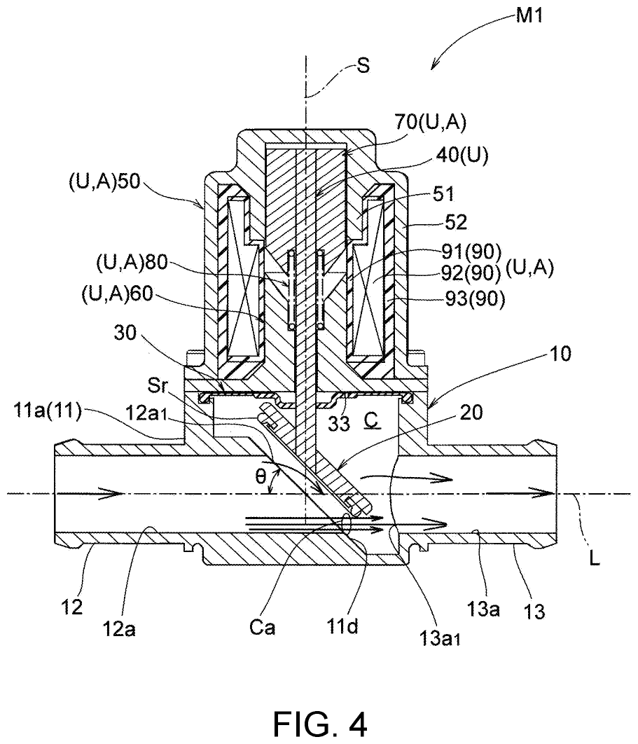

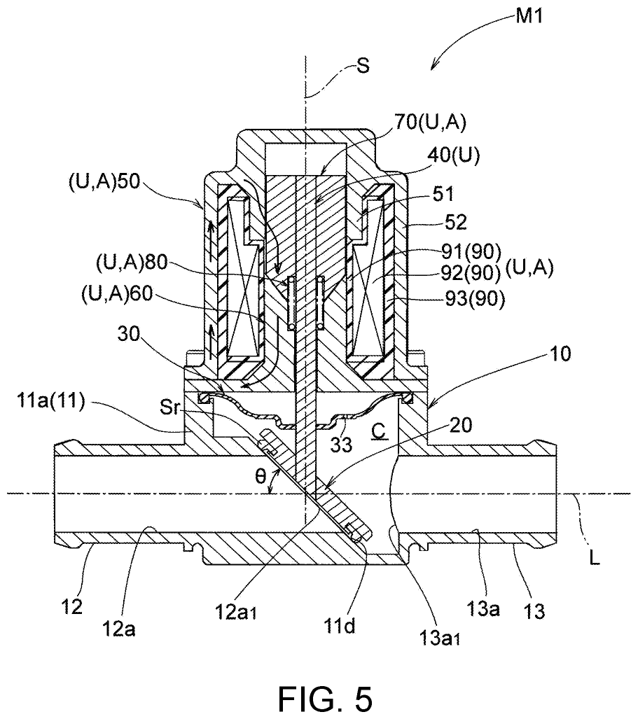

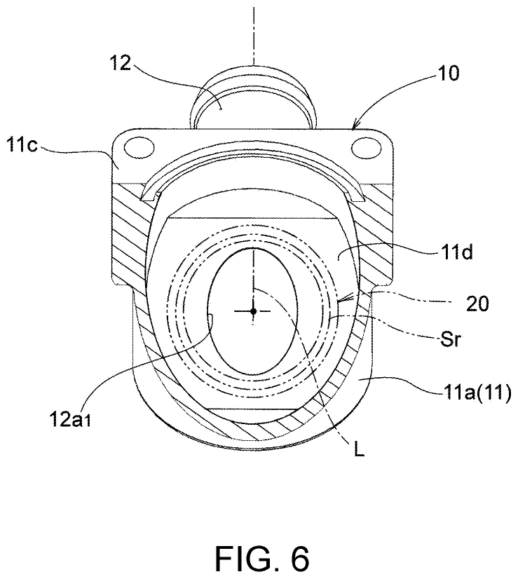

As shown in FIGS. 4 and 5, the valve seat surface 11d is formed as a planar surface, with the axis L as the center, inclined at a predetermined angle θ with respect to the axis L. In addition, as shown in FIG. 3, the valve seat surface 11d surrounds the periphery of an opening part 12a₁ open at a downstream end of the upstream side passage 12a. The opening part 12a₁ is circular when viewed from the direction of the axis L, but, as shown in FIG. 6, in an oval shape when viewed in a direction perpendicular to the valve seat surface 11d. Therefore, the valve seat surface 11d is formed so that the profile on the inner side is formed in an oval shape.

The upstream side pipe part 12 is a region in which a fluid lead-in pipe of an applicable object is connected, and defines the upstream side passage 12a of a circular cross-section with the axis L as the center.

The upstream side passage 12a is disposed on the axis L, and the downstream end thereof is in communication with the opening part 12a₁ open on the same surface with the valve seat surface 11d of the body part 11.
The downstream side pipe part 13 is a region in which a fluid lead-out pipe of the applicable object is connected, and defines the downstream side passage 13a of a circular cross-section with the axis L as the center.
The downstream side passage 13a is disposed on the axis L, and the upstream end thereof is in communication with the opening part 13a₁ open on the cylindrical wall 11a of the body part 11.

In the housing 10, the upstream side passage 12a and the downstream side passage 13a are arranged on the same axis L to be arranged linearly, and the valve seat surface 11d is disposed to be inclined to form the angle θ (45 degrees herein) with respect to the axis L, with the axis L as the center.

In addition, the operation chamber C is formed as a space in which the valve body 20 is able to be reciprocated within a predetermined range in the direction of the axis S of the shaft 40, and is interposed between the upstream side passage 12a and the downstream side passage 13a in the axis L.
That is, in the state in which the valve seat surface 11d and the operation chamber C are interposed, the upstream side passage 12a and the downstream side passage 13a are in linear communication, instead of communicating through a conventional curved passage. Therefore, in the region of a passage including the valve seat surface 11d, the loss of fluid pressure due to passage resistance can be reduced.

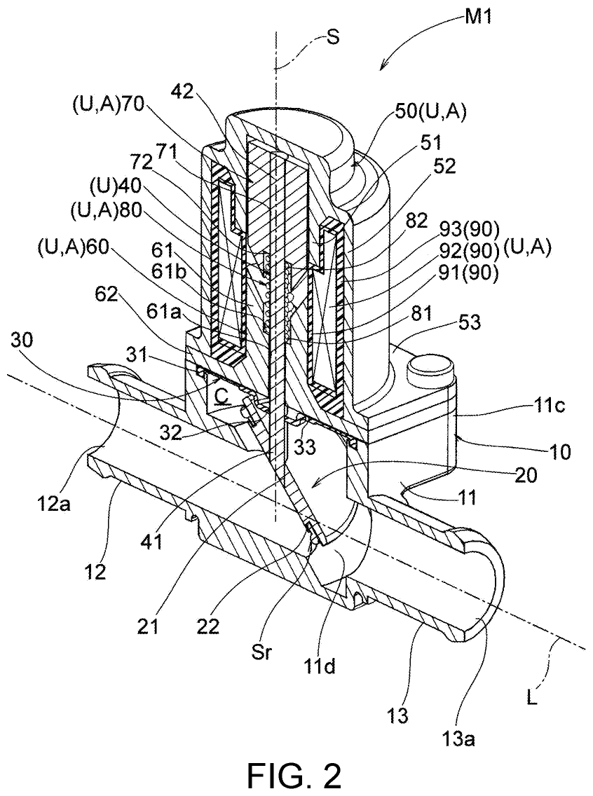

The valve body 20 is formed in a disc shape by using a metal material, such as stainless steel, and, as shown in FIG. 2, includes a fitting hole 21 into which the shaft 40 is fit and an annular groove 22 in the outer edge region.

An end 41 of the shaft 40 is linked to the fitting hole 21 through welding or press-fitting.
An annular seal member Sr abuttable with the valve seat surface 11d is mounted to the annular groove 22.
The seal member Sr is formed in an annular shape by using a rubber material, etc., and when the valve body 20 is located at a valve-closed position, the seal member Sr serves to be in close contact with the valve seat surface 11d and block the opening part 12a₁.

Here, the valve seat surface 11d, as shown in FIG. 6, is formed so that the inner profile defining the opening part 12a₁ forms an oval shape. However, the valve body 20 may also be formed in a disc-shaped plate, instead of being formed in an oval-shaped plate, and the seal member Sr is formed in an annular shape.

In this way, by forming the valve body 20 in a circular shape, compared with the case of an oval shape, the manufacturing cost of the valve body 20 can be reduced.

The seal member 30 is formed in a disc shape by using a rubber material, etc., that is membrane like and elastically deformable, and includes an annular fitting part 31, a central linking part 32, and a communication hole 33.

The communication hole 33 is formed in a size in which a foreign matter, etc., does not pass through, and contributes to a pressure regulation effect as a ventilation hole.
In addition, the seal member 30 is linked with the central linking part 32 through the shaft 40, and the annular fitting part 31 is fit with the annular groove 11c₁ of the housing 10 to be bonded to the casing (a second fixing element 60) of the driving unit U to be sandwiched.
In such assembled state, the seal member 30 provides a sealing function on the bonding surface between the housing 10 and the driving unit U, and is elastically deformed to move integrally with the shaft 40, so as to prevent a foreign matter, etc., in the fluid from entering the side of the electromagnetic actuator A. It is noted that the seal member 30 exerts a pressure regulation effect through the communication hole 33 during clastic deformation, so as not to obstruct the movement of the shaft 40.

The driving unit U includes the shaft 40 and the electromagnetic actuator A. The electromagnetic actuator A includes a first fixing element 50 and the second fixing element 60 as fixing elements defining the casing, a mover 70, a biasing member 80, and a coil module 90.

The coil module 90 includes a bobbin 91, a coil 92 for excitation, and a molded part 93 in which the bobbin 91 and the coil 92 are embedded.

The shaft 40 is formed in an elongated cylindrical columnar shape in the direction of the axis S by using a metal material such as stainless steel, and includes the end 41 linked to the valve body 20 and an other end 42 linked to the mover 70. The end 41 is fit with the fitting hole 21 of the valve body 20 through press-fitting or fit with the fitting hole 21 and welded. The other end 42 is fit with the fitting hole 71 of the mover 70 through press-fitting. In addition, the shaft 40 moves reciprocally in the direction of the axis S and moves integrally with the valve body 20 and the mover 70.

Here, the shaft 40 moves reciprocally in a direction (the direction of the axis S) perpendicular to the axis L in which the upstream side passage 12a and the downstream side passage 13a are arranged. That is, in the direction forming an angle (90 degrees−θ) with respect to the valve seat surface 11d, the valve body 20 is seated to or disengaged from the valve seat surface 11d.

Therefore, the shaft 40 receives a force, as a reaction force, in the radial direction when the valve body 20 is seated. Therefore, the guide hole 61a of the second fixing element 60 is set to a length in which the inclination of the shaft 40 is limited.

The first fixing element 50 functions as a magnetic path through which magnetic lines pass through and is formed by machining or forging using soft iron, etc., is formed in a bottomed cylindrical shape as shown in FIG. 2, and includes an inner cylindrical part 51, an outer cylindrical part 52, a flange part 53, and a notch part 54.

The inner cylindrical part 51 is formed in a bottomed cylindrical shape with the axis S as the center, and accommodates the mover 70 to be movable in the direction of the axis S.
The outer cylindrical part 52 is formed in a bottomed cylindrical shape with the axis S as the center, and accommodates the coil module 90 on the inner side.
The flange 53 is formed in a plate shape forming the outer profile of a substantially rectangular shape to correspond to the flange part 11c of the housing 10, and includes four circular holes (not shown) through which the fastening screws b pass. The notch part 54 is formed in a rectangular shape exposing a portion (a connector 93a) of the coil module 90.

The second fixing element 60 is formed by machining or forging using soft iron, etc., functions as a magnetic path through which magnetic lines pass, and functions as a fixed iron core attracting the mover 70 when the coil 92 is conducted with power. As shown in FIG. 2, the second fixing element 60 includes an inner cylindrical part 61 and a flange part 62.

The inner cylindrical part 61 includes a guide hole 61a with the axis S as the center and an annular concave part 61b with the axis S as the center.
The guide hole 61a slidably guides the shaft 40 in the direction of the axis S, and is set to a length that is two times or more of a lift amount of the valve body 20. Accordingly, the guide hole 61a can limit the inclination of the shaft 40 while smoothly guiding the shaft 40.
The annular concave part 61b serves to receive an end 81 of the biasing member 80 and position the end 81 in a direction perpendicular to the axis S.
The flange 62 is formed in a plate shape forming the outer profile of a substantially rectangular shape to correspond to the flange part 11c of the housing 10, and includes four circular holes (not shown) through which the fastening screws b pass.

The mover 70 functions as a magnetic path through which magnetic lines pass, and functions as a movable iron core moving in the direction of the axis S when the coil 92 is conducted with power, and is formed in a cylindrical shape by using free-cutting steel (SUM), etc., through machining or forging. As shown in FIG. 2, the mover 70 includes a fitting hole 71 and an annular concave part 72.

The fitting hole 71 is a region in which the other end 42 of the shaft 40 is press-fit, and is formed with an inner diameter slightly smaller than the outer diameter dimension of the shaft 40.
The annular concave part 72 serves to receive an other end 82 of the biasing member 80 and position the other end 82 in a direction perpendicular to the axis S.
It is noted that, for a smooth movement of the mover 70, for example, a groove hole elongated in the direction of the axis S may be formed on the outer circumferential surface, and when the mover 70 moves, the front-rear pressure may be adjusted.

The biasing member 80 is a compression-type coil spring. In the state in which an end 81 abuts against the annular concave part 61b of the second fixing element 60 and an other end 82 abuts against the annular concave part 72 of the mover 70, the biasing member 80 is contractably disposed in the direction of the axis S. In addition, the biasing member 80 supports the mover 70 that moves in the vertical direction (the direction of the axis S) from the bottom.

The coil module 90, as described above, includes the bobbin 91, the coil 92 for excitation, and the molding part 93.

The bobbin 91 is formed by using a resin material. As shown in FIG. 2, the bobbin 91 is fit around the peripheries of the inner cylindrical part 51 of the first fixing element 50 and the inner cylindrical part 61 of the second fixing element 60.
The coil 92 excites to generate a magnetic force through power conduction, and is wound around the bobbin 91 and connects two terminals (not shown).
The molding part 93 is an article molded by using a resin material, and, and is molded to cover the entirety and expose the two terminals in the connector 93a in the state in which the coil 92 is wound around the bobbin 91 and connects the two terminals.

Then, the operation of the valve device M1 according to the first embodiment is described.

Firstly, in a non-conduction state in which the coil 92 is not conducted with power, as shown in FIG. 4, the mover 70 and the shaft 40 are positioned at a rest position due to the biasing force of the biasing member 80. At the rest position, the valve body 20 is positioned at a valve-opened position which is disengaged from the valve seat surface 11d to open the opening part 12a₁.
At the valve-opened position, the fluid flowing in from the upstream side passage 12a flows along the surface of the inclined valve body 20, or linearly flows to the downstream side passage 13a without colliding with the valve body 20 at a region Ca deviated from the valve body 20.

Therefore, compared with the conventional case where the fluid collides head-on with the valve body, the loss of fluid pressure can be reduced. In addition, since the upstream side passage 12a and the downstream side passage 13a are arranged on the same axis L, the fluid can generate a linear flow, and the loss of fluid pressure can be reduced by reducing passage resistance.

In addition, it is also possible to adopt a driving unit with a large stroke and increase the lift amount of the valve body 20 and, at the valve-opened position, position the valve body 20 at a position deviated from the region in which the upstream side passage 12a and the downstream side passage 13a are connected linearly.
Accordingly, the fluid flowing in from the upstream side passage 12a does not collide with the valve body 20 and flows linearly toward the downstream side passage 13a. Accordingly, the loss of fluid pressure can be further reduced.

Meanwhile, when the coil 92 is conducted with power, as shown in FIG. 5, magnetic lines (electromagnetic force) from the first fixing element 50 toward the second fixing element 60 via the mover 70 are generated, and the mover 70 and the shaft 40 resist the biasing force of the biasing member 80 and are positioned at an operation position. At the operation position, the valve body 20 is seated at the valve seat surface 11d and is positioned at the valve-closed position that blocks the opening part 12a₁.

At the valve-closed position, the valve body 20 closes the valve in a direction resisting the fluid flowing in from the upstream side passage 12a. That is, the fluid flowing in from the upstream side passage 12a is in a state of applying a pressure for disengaging the valve body 20 from the valve seat surface 11d.

Therefore, in the state in which the valve body 20 is to be opened, even if the shaft 40 of the driving unit U remains still due to a stick phenomenon or the like, the pressure of the fluid increases, and the valve body 20 can be opened. In this way, a fail-safe function which opens the valve body 20 by using the fluid pressure can be attained.

The valve device M1 according to the first embodiment includes: the housing 10, defining the upstream side passage 12a and the downstream side passage 13a through which the fluid passes, the operation chamber C and the valve seat surface 11d interposed between the upstream side passage 12a and the downstream side passage 13a; the valve body 20, being reciprocated in the operation chamber C to be seated and disengaged with respect to the valve seat surface 11d; and the driving unit U, having the shaft 40 linked with the valve body 20 and driving the valve body 20. The upstream side passage 12a and the downstream side passage 13a are arranged on the same axis L, and the valve seat surface 11d is disposed to be inclined with respect to the axis L, with the axis L as the center. Accordingly, in the valve-opened state, the region Ca in which the fluid flows without colliding with the valve body 20 can be secured, or the fluid can linearly flow from the upstream side passage 12a toward the downstream side passage 13a, and the loss of fluid pressure can be reduced.

In addition, compared with the valve seat surface 11d whose profile on the inner side is formed in an oval shape, the valve body 20 is formed in a circular shape. Therefore, the manufacture of the valve body 20 is simplified, and the manufacturing cost can be lower than the case where the valve body 20 is formed in an oval shape.

In addition, since the annular seal member Sr abuttable with the valve seat surface 11d is mounted to the valve body 20, the sealing properties in the valve closed state can be facilitated.
In addition, the valve seat surface 11d is formed at the downstream end of the upstream end passage 12a, and the valve body 20 is closed in a direction resisting the fluid flowing in from the upstream side passage 12a. Therefore, even if the shaft 40 of the driving unit U remains still due to a stick phenomenon, etc., the valve body 20 can be opened due to the pressure of the fluid, and a fail-safe function can be attained.

In addition, since the driving unit U includes the electromagnetic actuator A applying a driving force to the shaft 40, by appropriately controlling ON/OFF of the electromagnetic force generated by the electromagnetic actuator A, the opening/closing operation of the valve body 20 can be carried out smoothly. In particular, the electromagnetic actuator A includes the fixing clement (the first fixing element 50 and the second fixing element 60), the coil 92 for excitation, and the mover 70 linked with the shaft 40 to move to the operation position by conducting power to the coil 92 and move to the rest position by not conducting power to the coil 92. Therefore, a desired driving force can be attained with a simple configuration.

In addition, with the rest position of the mover 70 corresponding to the valve-opened position at which the valve body 20 is disengaged from the valve seat surface 11d and the operation position of the mover 70 corresponding to the valve-closed position at which the valve body 20 is seated at the valve seat surface 11d, in the case where the fluid flow is in a basic mode, the coil 92 can be conducted with power to close the valve when necessary, and the power consumption can be suppressed.

In addition, with the shaft 40 of the driving unit U being disposed to be reciprocated in the direction perpendicular to the axis L that is the central line of the upstream side passage 12a and the downstream side passage 13a, the driving unit U can be formed to be compact with respect to the housing 10, and the size of the entire valve device M1 can be reduced.

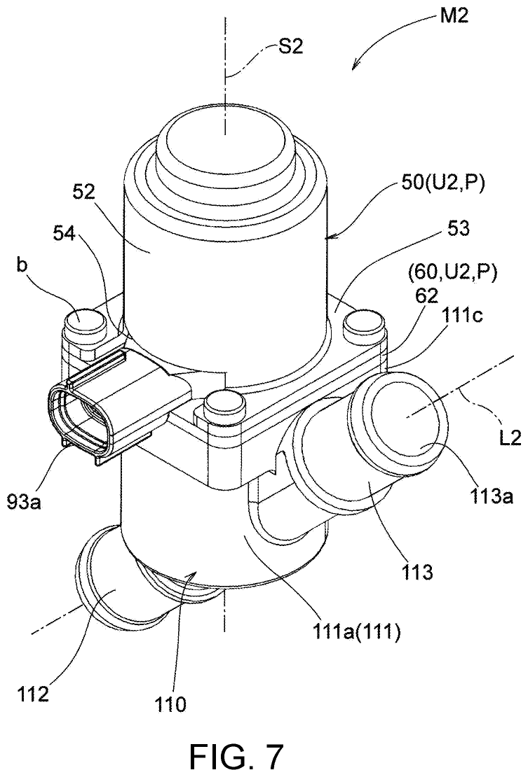

FIGS. 7 to 12 illustrate a valve device M2 according to the second embodiment of the invention, and those with the same configuration as the valve device M1 according to the first embodiment are labeled with the same reference symbols, and the description thereof is omitted.

The valve device M2 according to the second embodiment includes a housing 110, a valve body 120, the seal member 30, and a driving unit U2 fixed to the housing 110.
The driving unit U2 includes a shaft 140 and the electromagnetic actuator A (the first fixing element 50 and the second fixing element 60, the mover 70, the biasing member 80, and the coil module 90).

The housing 110 is formed by a resin material, etc., and includes a body part 111, an upstream side pipe part 112 with a center on an axis L2, and a downstream side pipe part 113 with a center on the axis L2.

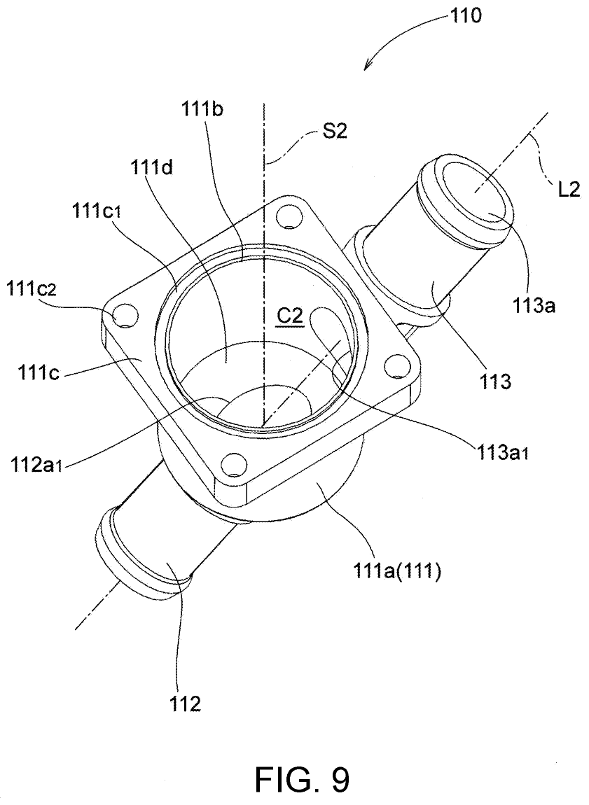

The body part 111, as shown in FIG. 9, includes a cylindrical wall 111a with an axis S2 intersecting with and inclined with respect to the axis L2 as the center, an opening part 111b, and a flange part 111c. In addition, inside the body part 111, a valve seat surface 111d on which the valve body 120 is allowed to be seated and an operation chamber C2 in which the valve body 120 moves reciprocally are defined.
The cylindrical wall 111a is formed in a cylindrical shape with the axis S2 as the center.
The opening part 111b is a region in which the operation chamber C2 is open toward the outer side, and is blocked by being bonded by the driving unit U2.

The flange part 111c is a region to which the driving unit U2 is bonded and fixed and formed in a substantially rectangular profile on the periphery of the opening part 111b, and includes an annular groove 111c₁ with which the seal member 30 is fit and four female screw holes 11c₂ into which the fastening screws b are screwed.

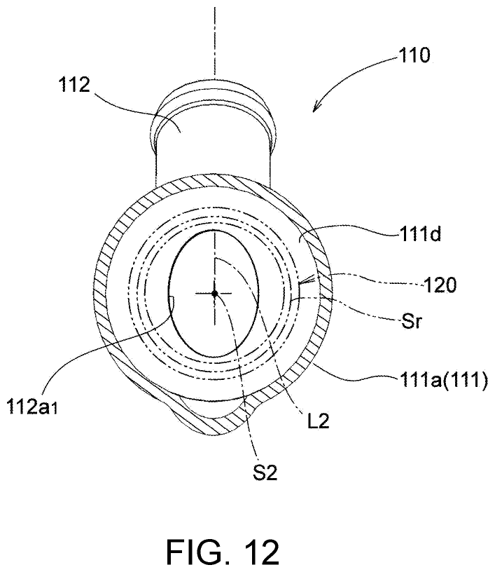

As shown in FIGS. 9 to 11, the valve seat surface 111d is formed as a planar surface, with the axis L2 as the center, inclined at the predetermined angle θ with respect to the axis L2. In addition, the valve seat surface 111d surrounds the periphery of an opening part 112a₁ open at a downstream end of the upstream side passage 112a.
The opening part 112a₁ is circular when viewed from the direction of the axis L2, but, as shown in FIG. 12, in an oval shape when viewed in a direction of the axis S2 perpendicular to the valve seat surface 111d. Therefore, the valve seat surface 111d is formed so that the profile on the inner side is formed in an oval shape.

The upstream side pipe part 112 is a region in which a fluid lead-in pipe of an applicable object is connected, and defines the upstream side passage 112a of a circular cross-section with the axis L2 as the center.

The upstream side passage 112a is disposed on the axis L2, and the downstream end thereof is in communication with the opening part 112a₁ open on the same surface with the valve seat surface 111d of the body part 111.
The downstream side pipe part 113 is a region in which a fluid lead-out pipe of the applicable object is connected, and defines the downstream side passage 113a of a circular cross-section with the axis L2 as the center.
The downstream side passage 113a is disposed on the axis L2, and the upstream end thereof is in communication with the opening part 113a₁ open on the cylindrical wall 111a of the body part 111.

In the housing 110, the upstream side passage 112a and the downstream side passage 113a are arranged on the same axis L to be arranged linearly, and the valve seat surface 111d is disposed to be inclined to form the angle θ (45 degrees herein) with respect to the axis L2, with the axis L2 as the center.

In addition, the operation chamber C2, is formed as a space in which the valve body 120 is able to be reciprocated within a predetermined range in the direction of the axis S2 of the shaft 140, and is interposed between the upstream side passage 112a and the downstream side passage 113a in the axis L2.
That is, in the state in which the valve seat surface 111d and the operation chamber C2 are interposed, the upstream side passage 112a and the downstream side passage 113a are in linear communication, instead of communicating through a conventional curved passage. Therefore, in the region of a passage including the valve seat surface 111d, the loss of fluid pressure due to passage resistance can be reduced.

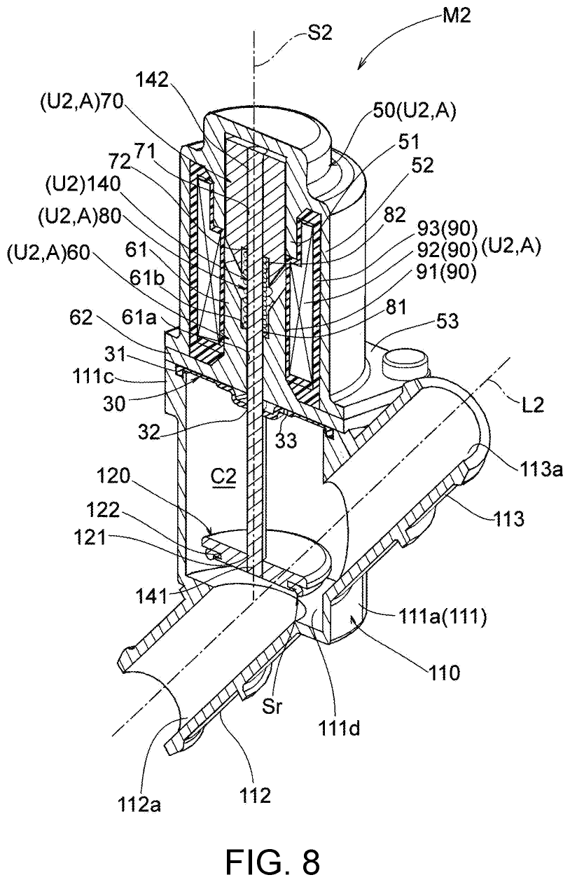

The valve body 120 is formed in a disc shape by using a metal material, such as stainless steel, and, as shown in FIG. 8, includes a fitting hole 121 into which the shaft 140 is fit and an annular groove 122 in the outer edge region.

An end 141 of the shaft 140 is linked to the fitting hole 121 through welding or press-fitting.
The annular seal member Sr abuttable with the valve seat surface 111d is mounted to the annular groove 122.

Here, the valve seat surface 111d, as shown in FIG. 12, is formed so that the inner profile defining the opening part 112a₁ forms an oval shape. However, the valve body 120 may also be formed in a disc-shaped plate, instead of being formed in an oval-shaped plate, and the seal member Sr is formed in an annular shape.

In this way, by forming the valve body 120 in a circular shape, compared with the case of an oval shape, the manufacturing cost of the valve body 120 can be reduced.

The shaft 140 is formed in an elongated cylindrical columnar shape in the direction of the axis S2 by using a metal material such as stainless steel, and includes the end 141 linked to the valve body 120 and an other end 142 linked to the mover 70. The end 141 is fit with the fitting hole 121 of the valve body 120 through press-fitting or fit with the fitting hole 121 and welded. The other end 142 is fit with the fitting hole 71 of the mover 70 through press-fitting. In addition, the shaft 140 moves reciprocally in the direction of the axis S2 and moves integrally with the valve body 120 and the mover 70.

Here, the shaft 140 moves reciprocally in a direction forming an angle (90 degrees−θ) with respect to the axis L2, that is, a direction perpendicular to the valve seat surface 111d.

Therefore, the shaft 140 receives a force, as a reaction force, in the direction of the axis S2 when the valve body 120 is seated. Therefore, the force acting to tilt the shaft 140 does not work.

Then, the operation of the valve device M2 according to the second embodiment is described.

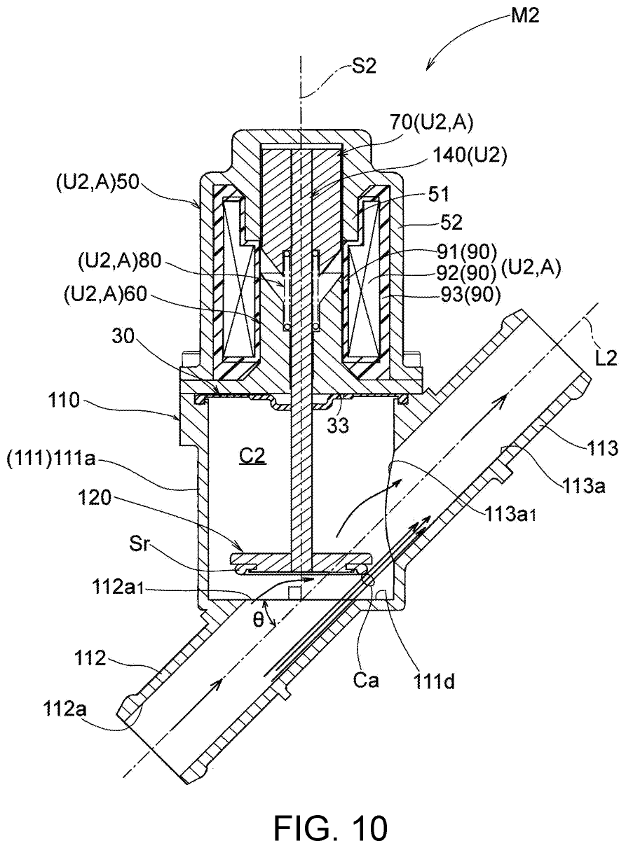

Firstly, in a non-conduction state in which the coil 92 is not conducted with power, as shown in FIG. 10, the mover 70 and the shaft 140 are positioned at a rest position due to the biasing force of the biasing member 80. At the rest position, the valve body 120 is positioned at a valve-opened position which is disengaged from the valve seat surface 111d to open the opening part 112a₁.
At the valve-opened position, the fluid flowing in from the upstream side passage 112a flows along the surface of the inclined valve body 120, or linearly flows to the downstream side passage 113a without colliding with the valve body 120 at the region Ca deviated from the valve body 120.

Therefore, compared with the conventional case where the fluid collides head-on with the valve body, the loss of fluid pressure can be reduced. In addition, since the upstream side passage 112a and the downstream side passage 113a are arranged on the same axis L2, the fluid can generate a linear flow, and the loss of fluid pressure can be reduced by reducing passage resistance.

In addition, it is also possible to adopt a driving unit with a large stroke and increase the lift amount of the valve body 120 and, at the valve-opened position, position the valve body 120 at a position deviated from the region in which the upstream side passage 112a and the downstream side passage 113a are connected linearly.
Accordingly, the fluid flowing in from the upstream side passage 112a does not collide with the valve body 120 and flows linearly toward the downstream side passage 113a. Accordingly, the loss of fluid pressure can be further reduced.

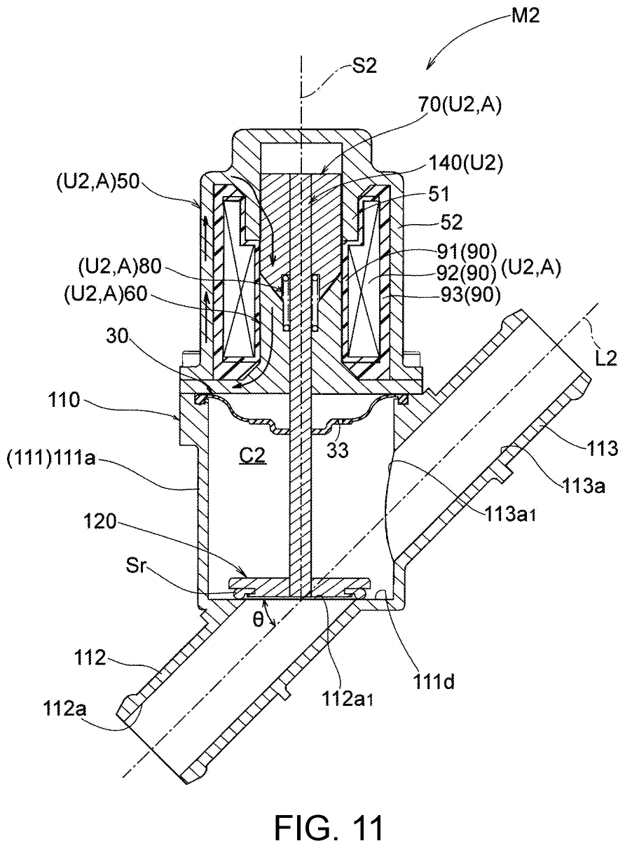

Meanwhile, when the coil 92 is conducted with power, as shown in FIG. 11, the mover 70 and the shaft 140 resist the biasing force of the biasing member 80 to be positioned at the operation position. At the operation position, the valve body 120 is seated at the valve seat surface 111d and positioned at the valve-closed position that blocks the opening part 112a₁.

At the valve-closed position, the valve body 120 closes the valve in a direction resisting the fluid flowing in from the upstream side passage 112a. That is, the fluid flowing in from the upstream side passage 112a is in a state of applying a pressure for disengaging the valve body 120 from the valve seat surface 111d.

Therefore, in the state in which the valve body 120 is to be opened, even if the shaft 140 of the driving unit U remains still due to a stick phenomenon or the like, the pressure of the fluid increases, and the valve body 120 can be opened. In this way, a fail-safe function which opens the valve body 120 by using the fluid pressure can be attained.

The valve device M2 according to the second embodiment includes: the housing 110. defining the upstream side passage 112a and the downstream side passage 113a through which the fluid passes, and the operation chamber C2 and the valve seat surface 111d interposed between the upstream side passage 112a and the downstream side passage 113a; the valve body 120, being reciprocated in the operation chamber C2 to be seated and disengaged with respect to the valve seat surface 111d; and the driving unit U2, having the shaft 140 linked with the valve body 120 and driving the valve body 120. The upstream side passage 112a and the downstream side passage 113a are arranged on the same axis L2, and the valve seat surface 111d is disposed to be inclined with respect to the axis L2, with the axis L2 as the center.

Accordingly, in the valve-opened state, the region Ca in which the fluid flows without colliding with the valve body 120 can be secured, or the fluid can linearly flow from the upstream side passage 112a toward the downstream side passage 113a, and the loss of fluid pressure can be reduced.

In addition, compared with the valve seat surface 111d whose profile on the inner side is formed in an oval shape, the valve body 120 is formed in a circular shape. Therefore, the manufacture of the valve body 120 is simplified, and the manufacturing cost can be lower than the case where the valve body 120 is formed in an oval shape.

In addition, since the annular seal member Sr abuttable with the valve seat surface 111d is mounted to the valve body 120, the sealing properties in the valve closed state can be facilitated.
In addition, the valve seat surface 111d is formed at the downstream end of the upstream end passage 112a, and the valve body 120 is closed in a direction resisting the fluid flowing in from the upstream side passage 112a. Therefore, even if the shaft 140 of the driving unit U2 remains still due to a stick phenomenon, etc., the valve body 120 can be opened due to the pressure of the fluid, and a fail-safe function can be attained.

In addition, since the driving unit U2 includes the electromagnetic actuator A applying a driving force to the shaft 140, by appropriately controlling ON/OFF of the electromagnetic force generated by the electromagnetic actuator A, the opening/closing operation of the valve body 120 can be carried out smoothly.

In addition, with the rest position of the mover 70 corresponding to the valve-opened position at which the valve body 120 is disengaged from the valve seat surface 111d and the operation position of the mover 70 corresponding to the valve-closed position at which the valve body 120 is seated at the valve seat surface 111d, in the case where the fluid flow is in a basic mode, the coil 92 can be conducted with power to close the valve when necessary, and the power consumption can be suppressed. In addition, with the shaft 140 of the driving unit U2 being disposed to be reciprocated in the direction perpendicular to the valve seat surface 111d, the force acting to tilt the shaft 140 does not work, and the shaft 140 can accurately move reciprocally.

In the embodiments, the driving unit U, U2 including the electromagnetic actuator A is shown as a driving unit having the shaft 40, 140 linked with the valve body 20, 120 and driving the valve body 20, 120, the invention is not limited thereto. A driving unit including a screw mechanism reciprocally moving a shaft or a driving unit including an operation part manually operating the screw mechanism may also be adopted.

In the embodiments, although fitting and/or welding is shown as the linking configuration between the valve body 20, 120 and the shaft 40, 140, the invention is not limited thereto. For example, a linking means using a link mechanism with which the valve body is swingable with respect to the shaft within a predetermined angle range may also be adopted.

In the embodiments, the first fixing element 50 and the second fixing element 60 forming the above configuration are shown as the fixing element of the electromagnetic actuator A included in the driving unit U, U2. However, first and second fixing elements forming other configurations may also be adopted.

In the embodiments, the case where the mover 70 of the electromagnetic actuator A included in the driving unit U moves in the vertical direction is shown. However, the invention is not limited thereto.

For example, in the case where the mover is used to be reciprocated in a direction other than the vertical direction, an electromagnetic actuator configured so that, at the rest position, the mover is biased by a biasing member and stopped by abutting against a stopper part provided at the first fixing element may also be adopted. Accordingly, the vibration of the mover, that is, the valve body, in the rest state can be avoided.

In the embodiments, the seal member 30 forming a configuration like a diaphragm is adopted to prevent a foreign matter, etc., in the fluid from entering the side of the electromagnetic actuator A. However, the invention is not limited thereto. It may also be that, a lip-type seal, for example, is fit to the end of the second fixing element to seal the periphery of the shaft. Accordingly, since the pressure of the fluid does not act on the movable portion, and the mover and the valve body can be driven by a smaller electromagnetic force.

According to the above, the valve device according to the invention can prevent the head-on collision of the fluid with the valve body and can reduce the loss of fluid pressure, or can reduce passage resistance. Therefore, in addition to being applicable to a cooling water circulation system of a vehicle, etc., the valve device is also useful in an apparatus controlling the flow of a fluid in other fields.

What is claimed is:

1. A valve device, comprising:
a housing, defining an upstream side passage and a downstream side passage through which a fluid passes and an operation chamber and a valve seat surface interposed between the upstream side passage and the downstream side passage;
a valve body, being reciprocated in the operation chamber to be seated and disengaged with respect to the valve seat surface; and
a driving unit, having a shaft linked with the valve body and driving the valve body,
wherein the upstream side passage and the downstream side passage are arranged on a same axis, and
the valve seat surface is disposed to be inclined with respect to the axis, with the axis as a center.

2. The valve device as claimed in claim 1, wherein in the valve seat surface, a profile on an inner side is formed in an oval shape, and
the valve body is formed in a circular shape.

3. The valve device as claimed in claim 2, wherein an annular seal member abuttable with the valve seat surface is mounted to the valve body.

4. The valve device as claimed in claim 1, wherein the valve seat surface is formed at a downstream end of the upstream side passage, and
the valve body closes as moving in a direction resisting the fluid flowing in from the upstream side passage.

5. The valve device as claimed in claim 1, wherein the driving unit comprises an electromagnetic actuator applying a driving force to the shaft.

6. The valve device as claimed in claim 5, wherein the electromagnetic actuator comprises: a fixing element; a coil for excitation; and a mover linked with the shaft, moving to an operation position by conducting power to the coil, and returning to a rest position by not conducting power to the coil.

7. The valve device as claimed in claim 6, wherein the rest position corresponds to a valve-opened position at which the valve body is disengaged from the valve seat surface, and the operation position corresponds to a valve-closed position at which the valve body is seated at the valve seat surface.

8. The valve device as claimed in claim 1, wherein the shaft is disposed to be reciprocated in a direction perpendicular to the axis.

9. The valve device as claimed in claim 1. wherein the shaft is disposed to be reciprocated in a direction perpendicular to the valve seat surface.
